(19) United States
(12) Patent Application Publication
(10) Pub. No.: US 2020/0188863 A1
(43) Pub. Date: Jun. 18, 2020

(54) POLYOLEFIN MICROPOROUS MEMBRANE, SEPARATOR FOR BATTERIES, AND METHODS RESPECTIVELY OF PRODUCING THE MEMBRANE AND THE SEPARATOR

(71) Applicant: Toray Industries, Inc., Tokyo (JP)

(72) Inventors: Naoki Mizuno, Nasushiobara (JP); Masami Sugata, Nasushiobara (JP)

(21) Appl. No.: 16/089,003

(22) PCT Filed: Mar. 1, 2017
(86) PCT No.: PCT/JP2017/008135

§ 371 Date: Sep. 27, 2018

(30) Foreign Application Priority Data
Mar. 29, 2016 (JP) 2016-065652

(51) Int. Cl. B01D 71/26; H01M 2/16; H01M 2/14; B01D 69/12; B01D 67/00

(52) U.S. Cl. CPC B01D 71/26; H01M 2/1653; H01M 2/1686; H01M 2/145; B01D 2323/42; B01D 67/002; B01D 2325/02; B01D 2325/04; B01D 69/12

(57) ABSTRACT

A polyolefin microporous membrane on which a porous layer has little fluctuations in thickness and a separator for batteries can adapt to the increase in capacity of a battery. A polyolefin microporous membrane having a range of fluctuation in a F25 value in the width direction of 1 MPa or less, a thickness of 3 μm or more and less than 7 μm and a width of 100 mm or more (wherein the term “F25 value” refers to a value produced by dividing the value of a load applied to a test specimen upon the stretching of the test specimen at a stretching ratio of 25% using a tension tester by the value of a cross-sectional area of the test specimen).

### TECHNICAL FIELD

This disclosure relates to a polyolefin microporous membrane, a battery separator including a porous layer on at least one surface of the polyolefin microporous membrane and methods of producing them.

### BACKGROUND

A thermoplastic resin-made microporous membrane is widely used as a membrane for separation of substances, a membrane for selective permeation of substances, a membrane for isolation of substances and the like. Examples thereof include, for example, a battery separator to be used in a lithium ion secondary battery, nickel-hydrogen battery, nickel-cadmium battery or polymer battery; a separator for electric double layer capacitors; various filters such as reverse osmosis filtration membrane, ultrafiltration membrane and microfiltration membrane; a moisture-permeable waterproof clothing; a medical material and the like.

In particular, a polyethylene-made microporous membrane is suitably used as a lithium ion secondary battery separator, the polyethylene-made microporous membrane ensuring ion permeability due to impregnation with an electrolytic solution, excellent electrical insulating properties, and a pore blocking function of avoiding an excessive temperature rise by cutting off a current at a temperature of approximately 120 to 150° C. when the temperature in a battery shows an abnormal rise. However, if the temperature rise in the battery continues for some reasons even after pore blocking, the polyethylene-made microporous membrane may shrink and rupture. This phenomenon is not limited to the polyethylene-made microporous membrane, but even in a microporous membrane using other thermoplastic resins, the phenomenon above cannot be avoided at a temperature not less than the melting point of the resin.

Furthermore, the lithium ion secondary battery separator greatly affects battery properties, battery productivity and battery safety, and requires heat resistance, electrode adhesion, permeability, melt rupture property (meltdown property) and the like. It has hitherto been studied to impart heat resistance and adhesiveness to a battery separator, for example, by providing a porous layer on a polyolefin microporous membrane. As resins used for the porous layer, polyamideimide resins, polyimide resins and polyamide resins, which have good heat resistance and fluororesins which have good adhesiveness are suitably used. In addition, in recent years, a water-soluble or water-dispersible binder which can be used to laminate the porous layer by a relatively easy process has also been used. The porous layer is a layer obtained by a wet coating process.

In Example 5 of JP-A-2007-273443, a polyethylene microporous membrane having a thickness of 20 μm obtained by a simultaneous biaxial stretching method is coated with an aqueous solution in which titania particles and polyvinyl alcohol are uniformly dispersed, by using a gravure coater, followed by drying at 60° C. to remove water to obtain a multilayer porous membrane having a total thickness of 24 μm (coating thickness: 4 μm).

In Example 3 of JP-A-2008-186721, a polyethylene microporous membrane having a thickness of 16 μm obtained by a simultaneous biaxial stretching method is coated with an aqueous solution in which titania particles and polyvinyl alcohol are uniformly dispersed, by using a bar coater, followed by drying at 60° C. to remove water to obtain a multilayer porous membrane having a total thickness of 19 μm (coating thickness: 3 μm).

In Example 1 of JP-A-2009-026733, a multilayer porous membrane is obtained by the same method as in Example 3 of JP-A-2008-186721, except that a gravure coater is used.

In Example 6 of WO-A1-2008-149895, a polyethylene microporous membrane having a thickness of 11 to 18 μm obtained by a sequential biaxial stretching method is allowed to pass between Meyer bars on which an appropriate amount of a coating solution containing a meta-type wholly aromatic polyamide, alumina particles, dimethylacetamide (DMAc) and tripropylene glycol (TPG) is applied, followed by coagulation and water washing-drying steps to obtain a nonaqueous secondary battery separator in which a heat-resistant porous layer is formed.

In JP-A-2010-092882, a polyethylene microporous membrane having a thickness of 10 to 12 μm obtained by a sequential biaxial stretching method is allowed to pass between facing Meyer bars on which an appropriate amount of a coating solution containing a meta-type wholly aromatic polyamide, aluminum hydroxide, dimethylacetamide and tripropylene glycol is applied, followed by coagulation and water washing-drying steps to obtain a nonaqueous secondary battery separator in which a heat-resistant porous layer is formed.

In JP-A-2009-205955, a polyethylene microporous membrane having a thickness of 12 μm obtained by a sequential biaxial stretching method is allowed to pass between facing Meyer bars on which an appropriate amount of a coating solution containing polymetaphenylene isophthalamide, aluminum hydroxide particles, dimethylacetamide (DMAc) and tripropylene glycol (TPG) is applied, followed by coagulation and water washing-drying steps to obtain a nonaqueous secondary battery separator in which a heat-resistant porous layer is formed.

In JP-A-2012-020437, a non-porous membrane-like material of a three-layer structure having a layer containing polypropylene in which a β crystal nucleating agent is allowed to be contained, as an outer layer, is stretched in a longitudinal direction using a longitudinal stretching device, followed by being coated with an aqueous dispersion containing alumina particles and polyvinyl alcohol using Meyer bars and, thereafter, the resultant is stretched in a transverse direction at a stretch ratio of 2 times, followed by performing heat setting/relaxing treatment to obtain a multilayer porous film, by a so-called combination of a sequential biaxial stretching method and an in-line coating method.

JP-A-2013-530261 exemplifies a separation membrane obtained by a sequential biaxial stretching method using a stretching method in which the contact angle between a material to be stretched and a stretching roller is set to be equal to or larger than a certain value in a longitudinal stretching device having four stretching rollers.

In recent years, lithium ion secondary batteries have been studied for a wide variety of uses such as lawn mowers, weed whackers and small boats, in addition to electric vehicles, hybrid vehicles and electric bicycles. Therefore, batteries large in size compared to small-sized electronic devices such as conventional cell phones and mobile information terminals have become necessary. Accordingly, also in separators to be assembled in the batteries, ones having a width as large as 100 mm or more are in demand.

However, as the width of the polyolefin microporous membrane is larger, it becomes more difficult to provide a porous layer having a uniform thickness in a width direction by coating. In particular, when a Meyer bar is used, deflection occurs in the Meyer bar itself when the coating width increases and uniform coating is difficult.

When the thickness of the porous layer is uneven (that is, the thickness variation range of the porous layer is large), for example, when partially thin portions are generated in the porous layer, the average thickness is required to be 1.5 to 2 times the necessary minimum thickness to sufficiently ensure the functions of the porous layer. This results in a factor for cost increase. In accordance with this, the thickness of a separator increases to cause a decrease in the number of turns in an electrode roll, which also results in a factor that hinders an increase in capacity.

In addition, when the thickness variation range of the porous layer is large, a streak-like depression or a convex streak occurs in a separator roll, or wavy wrinkles occur at edges of the roll. This exerts an adverse influence on a winding appearance of the separator roll. This tendency may be remarkable as the number of turns of the roll increases, and it is anticipated that the number of turns of the roll will further increase due to a decrease in thickness of the separator. In particular, in the production of the polyolefin microporous membrane having a thickness of less than 7 μm, flapping in the course of transport readily occurs and tension is unstable. In reality, therefore, it is extremely difficult to obtain a uniform polyolefin microporous membrane having a variation range of an F25 value in a width direction of 1 MPa or less.

When an increase in battery size and an increase in battery capacity are assumed, it is difficult to provide the porous layer having a uniform thickness in the width direction on the wide polyolefin microporous membrane by a conventional coating technology, and the winding appearance of the roll cannot be sufficiently satisfied, leading to a decrease in production yield.

It could therefore be helpful to provide a polyolefin microporous membrane suitable for a porous layer having a uniform thickness, the polyolefin microporous membrane having a thickness of 3 μm or more and less than 7 μm, a width of 100 mm or more and a variation range of an F25 value in a width direction of 1 MPa or less. In addition, it could be helpful to provide a battery separator which is suitable for an increase in capacity of a battery and in which a porous layer having a uniform thickness is placed on the above-mentioned polyolefin microporous membrane. The porous layer having a uniform thickness means that the porous layer has the thickness variation range (R) in the width direction of 1.0 μm or less.

### SUMMARY

We thus provide:

(1) A polyolefin microporous membrane having a variation range of an F25 value in a width direction of 1 MPa or less, a thickness of 3 μm or more and less than 7 μm and a width of 100 mm or more (wherein the F25 value indicates a value obtained by dividing a load value measured at 25% elongation of a specimen with use of a tensile tester by a cross-sectional area of the specimen).

(2) A battery separator, comprising the polyolefin microporous membrane according to (1) and a porous layer placed on at least one surface of the polyolefin microporous membrane, wherein the porous layer contains a particle and at least one binder selected from the group consisting of a fluororesin, an acrylic resin, a polyvinyl alcohol resin, a cellulose resin and a derivative thereof and has an average thickness T(ave) of 1 to 5 μm.

(3) In the battery separator, it is preferred that the porous layer has a thickness variation range (R) in a width direction of 1.0 μm or less.

(4) It is preferred that the polyolefin microporous membrane has a width of 150 mm or more.

(5) It is preferred that the polyolefin microporous membrane has a width of 200 mm or more.

(6) A method of producing the polyolefin microporous membrane according to (1), the method comprising:

(a) a step of melt-kneading a polyolefin resin and a forming solvent, thereby preparing a polyolefin resin solution;

(b) a step of extruding the polyolefin resin solution into a sheet shape via an extruder and cooling an extrudate thereof, thereby forming an unstretched gel-like sheet;

(c) a step of passing the unstretched gel-like sheet between at least two pairs of longitudinal stretching roller groups and stretching it in a longitudinal direction by the two pairs of roller groups different in the peripheral speed ratio, thereby forming a longitudinally stretched gel-like sheet (wherein a longitudinal stretching roller and a nip roller parallelly contacting therewith are designated as a pair of longitudinal stretching roller group, and a contact pressure of the nip roller to the longitudinal stretching roller is 0.05 MPa or more and 0.5 MPa or less);

(d) a step of stretching the longitudinally stretched gel-like sheet in a transverse direction while holding it to allow a clip-to-clip distance to be 50 mm or less at a tenter outlet, thereby obtaining a biaxially stretched gel-like sheet;

(e) a step of extracting the forming solvent from the biaxially stretched gel-like sheet and drying it; and

(f) a step of heat-treating the dried sheet, thereby obtaining a polyolefin microporous membrane.

(7) The method of producing a polyolefin microporous membrane roll includes a step of winding a polyolefin microporous membrane obtained by the method for producing the polyolefin microporous membrane according to the above (6) on a winding core at a transport rate of 50 m/min or more.

(8) The method of producing a battery separator includes a step of coating at least one surface of a polyolefin microporous membrane obtained by the method for producing the polyolefin microporous membrane according to (6) with a coating solution containing a particle and at least one binder selected from the group consisting of a fluororesin, an acrylic resin, a polyvinyl alcohol resin, a cellulose resin and a derivative thereof by a roll coating method so that a thickness of a coating contact line between a coating roller and the polyolefin microporous membrane is 3 mm or more and 10 mm or less, followed by drying.

(9) In the method of producing a battery separator, it is preferred that the coating roller is a gravure roller.

A polyolefin microporous membrane suitable for providing a porous layer having a uniform thickness and has a variation range of an F25 value in a width direction of 1 MPa or less, a thickness of 3 μm or more and less than 7 μm and a width of 100 mm or more is obtained. In addition, a battery separator suitable for an increase in capacity of a battery and in which a porous layer having a uniform thickness is placed on the polyolefin microporous membrane is obtained.

### BRIEF DESCRIPTION OF THE DRAWINGS

FIG. 1 is a schematic diagram illustrating a longitudinal stretching device (1) used for sequential biaxial stretching.

FIG. 2 is a schematic diagram illustrating a longitudinal stretching device (2) used for sequential biaxial stretching.

FIG. 3 is a schematic diagram illustrating a longitudinal stretching device (3) used for sequential biaxial stretching.

FIG. 4 is a schematic diagram illustrating an example of a longitudinal stretching device used in the re-stretching step.

FIG. 5 is a schematic diagram illustrating an example of a coating device.

### DESCRIPTION OF REFERENCE NUMERALS AND SIGNS

1. Longitudinal stretching roller

2. Nip roller

3. Blade

4. Unstretched gel-like sheet

5. Biaxially stretched sheet

6. Longitudinal re-stretching roller

7. Nip roller for longitudinal re-stretching

8. Polyolefin microporous membrane

9. Coating roller

10. Coating contact line

11. Back roller

12. Roller position adjusting direction

### DETAILED DESCRIPTION

In the polyolefin microporous membrane, the thickness is 3 m or more and less than 7 μm, the width is 100 mm or more, and the variation range of the F25 value in the width direction is 1 MPa or less (the F25 value indicates a value obtained by dividing a load value measured at 25% elongation of a specimen with use of a tensile tester by a cross-sectional area of the specimen).

By using a polyolefin microporous membrane having a variation range of the F25 value in the width direction of 1 MPa or less, the following excellent effects are achieved: the contact pressure at a contact line of the polyolefin microporous membrane and the coating roller (hereinafter, simply referred to as “coating contact line”) is likely to be uniform relative to the width direction of the polyolefin microporous membrane and the coating thickness can be easily made uniform. If the variation range of the F25 value in the width direction exceeds 1 MPa, the polyolefin microporous membrane may meander during transport in a slitting step or coating step to deteriorate the winding appearance of the roll, and this may be prominently found, for example, in processing at such a high speed as providing a transport rate of 50 m/min or more during winding onto a winding core.

### 1. Polyolefin Microporous Membrane

First, the polyolefin porous membrane is described.

In the polyolefin microporous membrane, the variation range of the F25 value in the width direction is 1 MPa or less, preferably 0.8 MPa or less, more preferably 0.6 MPa or less, and most preferably 0.4 MPa or less. As described below, the variation range of the F25 value in the width direction of the polyolefin microporous membrane can be controlled in particular by highly controlling the longitudinal stretching step and the transverse stretching step.

As the polyolefin resins configuring the polyolefin microporous membrane, examples thereof include homopolymers, two-stage-polymerized polymers and copolymers, each obtained by polymerizing ethylene, propylene, 1-butene, 4-methyl-1-pentene, 1-hexene and the like, or mixtures thereof and the like. Various additives such as an antioxidant and an inorganic filler may be added to the polyolefin resin, if needed, as long as the desired effects are not impaired.

The polyolefin resin preferably contains a polyethylene resin as a main component. When the total mass of the polyolefin resin is defined as 100% by mass, the content of the polyethylene resin is preferably 70% by mass or more, more preferably 90% by mass or more, and still more preferably 100% by mass.

Examples of the polyethylene include a ultrahigh-molecular-weight polyethylene, a high-density polyethylene, a medium-density polyethylene, a low-density polyethylene and the like. Such a polyethylene may not only be a homopolymer of ethylene but also be a copolymer containing a small amount of other α-olefin. As the α-olefin other than ethylene, suitable examples thereof include propylene, 1-butene, 1-pentene, 1-hexene, 4-methyl-1-pentene, 1-octene, (meth)acrylic acid, (meth)acrylic acid ester, styrene and the like. The polyethylene may be a single polyethylene but is preferably a polyethylene mixture composed of two or more polyethylenes. The polymerization catalyst is not particularly limited, and a Ziegler-Natta catalyst, a Phillips catalyst, a metallocene catalyst or the like may be used.

As the polyethylene mixture, a mixture of two or more kinds of ultrahigh-molecular-weight polyethylenes differing in the weight average molecular weight (Mw), a mixture of two or more kinds of high-density polyethylenes differing in the weight average molecular weight (Mw), a mixture of two or more kinds of medium-density polyethylenes differing in the weight average molecular weight (Mw), or a mixture of two or more kinds of low-density polyethylenes differing in the weight average molecular weight (Mw) may be used, or a mixture of two or more kinds of polyethylenes selected from the group consisting of an ultrahigh-molecular-weight polyethylene, a high-density polyethylene, a medium-density polyethylene and a low-density polyethylene may be used. The polyethylene mixture is preferably a mixture of an ultrahigh-molecular-weight polyethylene having a weight average molecular weight of 5×10⁵ or more and a polyethylene having a weight average molecular weight of 1×10⁴ or more and less than 5×10⁵. The content of the ultrahigh-molecular-weight polyethylene in the mixture is preferably 1 to 40 wt % in view of tensile strength.

The molecular weight distribution (weight average molecular weight (Mw)/number average molecular weight (Mn)) of the polyethylene is preferably 5 to 200 in view of mechanical strength.

### 2. Production Method of Polyolefin Microporous Membrane

Next, the method of producing the porous microporous membrane is described.

As the method of producing the polyolefin microporous membrane, examples thereof include a dry process (a method of forming micropores by not using a forming solvent but using a crystal nucleating agent or a particle (also called a stretching pore-opening method) and a wet process (phase separation method), and in view of homogenization of micropores and planarity, the wet process is preferred.

Examples of the production method by a wet process include, for example, a method where a polyolefin and a forming solvent are heated and melt-kneaded, the obtained resin solution is extruded through a die and cooled to form an unstretched gel-like sheet, and the resulting unstretched gel-like sheet is stretched in at least one axis direction and after removing the forming solvent, the stretched sheet is dried to obtain a microporous membrane.

The polyolefin microporous membrane may be a single-layer membrane or may be a layer structure including two or more layers differing in the molecular weight or average pore size. In the layer structure including two or more layers, the molecular weight and molecular weight distribution of the polyethylene resin in at least one outermost layer preferably satisfy the ranges above.

As the method of producing a multilayer polyolefin microporous membrane including two or more layers, the membrane can be manufactured either by a method where each of the olefins constituting layer a and layer b and a forming solvent are heated and melt-kneaded and the obtained resin solutions are supplied to one die from respective extruders, combined and co-extruded, or a method where gel-like sheets constituting respective layers are laminated and thermally fusion-bonded. A co-extrusion method is preferred because an interlayer adhesion strength is easily obtained, a communication hole is easy to be formed between layers, making it easy to maintain high permeability, and moreover, the productivity is excellent.

A production method of obtaining the polyolefin microporous membrane is described in detail.

The above-mentioned unstretched gel-like sheet is stretched in biaxial directions which are a machine direction (also referred to as “MD” or “longitudinal direction”) and a width direction (also referred to as “TD” or “transverse direction”), at predetermined ratios, by a roller method, a tenter method or a combination of these methods. Both of a sequential biaxial stretching method in which after the unstretched gel-like sheet is longitudinally stretched, both ends of the sheet are fixed by clips and transverse stretching is performed in a tenter and a simultaneous biaxial stretching method in which both ends of the unstretched gel-like sheet are fixed by clips and longitudinal stretching and transverse stretching are simultaneously performed can be adopted. In particular, the sequential biaxial stretching method is more preferred, because stretching can be performed in the transverse direction while keeping a clip-to-clip distance small and, therefore, variation in quality of the sheet in the width direction is hard to occur, resulting in easy prevention of an increase in the variation range of the F25 value in the width direction.

An example of the method of producing the polyolefin microporous membrane is described by taking the sequential biaxial stretching method as an example.

The method of producing the polyolefin microporous membrane includes the following steps (a) to (f):

(a) a step of melt-kneading a polyolefin resin and a forming solvent, thereby preparing a polyolefin resin solution;

(b) a step of extruding the above-mentioned polyolefin resin solution and cooling an extrudate thereof, thereby forming an unstretched gel-like sheet;

(c) a longitudinal stretching step of stretching the above-mentioned unstretched gel-like sheet in a longitudinal direction, thereby forming a longitudinally stretched gel-like sheet;

(d) a step of stretching the above-mentioned longitudinally stretched gel-like sheet in a transverse direction while holding it to allow a clip-to-clip distance to be 50 mm or less at a tenter outlet, thereby obtaining a biaxially stretched gel-like sheet;

(e) a step of removing the forming solvent from the above-mentioned biaxially stretched gel-like sheet and drying it; and

(f) a step of heat-treating the dried sheet, thereby obtaining a polyolefin microporous membrane.

Furthermore, a corona treatment step and the like may be optionally provided after the steps (a) to (f).

### (a) Preparation Step of Polyolefin Resin Solution

As the preparation step of polyolefin resin solution, a forming solvent is added to a polyolefin resin, and the mixture is then melt-kneaded to prepare a polyolefin resin solution. As the melt-kneading method, a method using a twin-screw extruder described, for example, in JP-B-H06-104736 and Japanese Patent No. 3347835 can be used. Since the melt-kneading method is publicly known, description thereof is omitted.

The forming solvent is not particularly limited as long as it can dissolve the polyethylene sufficiently. Examples thereof include an aliphatic or cyclic hydrocarbon such as nonane, decane, undecane, dodecane and liquid paraffin, and a mineral oil fraction of which boiling point corresponds to the hydrocarbon above, and a non-volatile solvent such as liquid paraffin is preferred.

The polyolefin resin concentration in the polyolefin resin solution is preferably 25 to 40 parts by weight per 100 parts by weight of a total of the polyolefin resin and the forming solvent. When the polyolefin resin concentration falls within the preferable range above, swelling or neck-in at the die outlet can be prevented during the extrusion of the polyolefin resin solution, and the formability and self-supporting property of the gel-like sheet are maintained.

### (b) Step of Forming Unstretched Gel-Like Sheet

As the step of forming unstretched gel-like sheet, the polyolefin resin solution is fed to a die from the extruder directly or via another extruder, extruded in a sheet shape, and cooled to form an unstretched gel-like sheet. A plurality of polyolefin solutions having the same or different compositions may also be fed to one die from the extruder, laminated in layers there and extruded in a sheet shape.

The extrusion method may be either a flat die method or an inflation method. The extrusion temperature is preferably 140 to 250° C., and the extrusion rate is preferably 0.2 to 15 m/min. The thickness can be adjusted by adjusting the extrusion amount of each of the polyolefin solutions. As for the extrusion method, a method disclosed, for example, in JP-B-H06-104736 and Japanese Patent No. 3347835 can be utilized.

A gel-like sheet is formed by cooling the polyolefin resin solution extruded in a sheet shape. As the cooling method, for example, a method of bringing the extrudate into contact with a cooling medium such as cold air and cooling water, or a method of bringing the extrudate into contact with a cooling roller can be used, and it is preferable to cool the extrudate by bringing it into contact with a roller cooled by a cooling medium. For example, the polyolefin resin solution extruded in a sheet shape is brought into contact with a rotating cooling roller set at a surface temperature of 20 to 40° C. by a cooling medium, and an unstretched gel-like sheet can thereby be formed. The extruded polyolefin resin solution is preferably cooled to 25° C. or less.

### (c) Longitudinal Stretching Step

As the longitudinal stretching step, the unstretched gel-like sheet obtained in the above-mentioned step is allowed to pass through a plurality of pre-heat rollers to increase the temperature to a predetermined temperature, and thereafter allowed to pass through at least two pairs of longitudinal stretching roller groups different in peripheral speed, thereby performing stretching in the longitudinal direction to obtain a longitudinally stretched gel-like sheet.

From the viewpoint of controlling the F25 value in the width direction, it is important to avoid sheet slip in longitudinal stretching to perform uniform longitudinal stretching.

In the longitudinal stretching step, a longitudinal stretching roller and a nip roller are designated as a pair of roller groups, and longitudinal stretching is performed by allowing the unstretched gel-like sheet to pass between at least two pairs of rollers different in peripheral speed. The nip roller is disposed to contact with the longitudinal stretching roller in parallel at a constant pressure, brings the unstretched gel-like sheet into close contact on the longitudinal stretching roller, thereby making it possible to stably transport the sheet, and fix a stretching position of the sheet, and thus, uniform longitudinal stretching can be performed. An effect of avoiding the slip of the sheet cannot be sufficiently obtained only by increasing the contact area between the longitudinal stretching roller and the gel-like sheet without using the nip roller, and the variation range of the F25 value may be increased. To perform uniform longitudinal stretching, the longitudinal stretching step is preferably performed at a desired stretch ratio by two or more-stage stretching rather than single-stage stretching. That is, it is preferred to arrange three or more longitudinal stretching rollers.

The temperature in the longitudinal stretching step is not more than “melting point of polyolefin resin+10° C.”. Furthermore, in view of elasticity and strength of the polyolefin microporous membrane, the stretch ratio is preferably 3 times or more, more preferably 4 to 10 times.

As for the surface temperature of the longitudinal stretching roller, for each of the rollers, it is important to control the surface temperature to be uniform in the effective width of the stretching roller (the width through which the sheet under stretching passes). The “surface temperature of the longitudinal stretching roller being uniform” indicates that the variation range of the surface temperature in the measurement of temperature at 5 points in the width direction is within ±+2° C. The surface temperature of the longitudinal stretching roller can be measured, for example, by an infrared radiation thermometer.

The longitudinal stretching roller is preferably a metal roller having a surface roughness of 0.3 S to 5.0 S and having been subjected to hard chromium plating. When the surface roughness falls within this range, good thermal conductance is achieved, and due to synergy with the nip roller, sheet slip can be effectively avoided.

In the longitudinal stretching step, when it is intended to avoid sheet slip only by the use of one nip roller, the pressure on the nip roller in contact with the stretching roller (sometimes referred to as “nip pressure”) must be increased and may cause collapse of micropores in the obtained polyolefin microporous membrane. It is preferable to make the nip pressure on the longitudinal stretching roller paired with each nip roller relatively small by using a plurality of nip rollers. The nip pressure of each nip roller is 0.05 MPa or more and 0.5 MPa or less. If the nip pressure of the nip roller exceeds 0.5 MPa, micropores in the obtained polyolefin microporous membrane may collapse. If the nip pressure is less than 0.05 MPa, due to an insufficient nip pressure, the effect of avoiding the slip is not obtained and in addition, an effect of squeezing the forming solvent is also less likely to be obtained. The “squeezing effect” indicates that by squeezing out the forming solvent from the unstretched gel-like sheet or the gel-like sheet under longitudinal stretching, slip against the longitudinal stretching roller can be avoided and stretching can be stably performed. The lower limit of the nip pressure of the nip roller is preferably 0.1 MPa, more preferably 0.2 MPa, and the upper limit is preferably 0.5 MPa, more preferably 0.4 MPa. When the nip pressure of the nip roller falls within the range above, an appropriate effect of avoiding the slip is obtained.

In addition, the nip roller needs to be covered with a heat-resistant rubber. During the longitudinal stretching step, the forming solvent may bleed out from the gel-like sheet due to heat or pressure by tension, and in particular, the bleeding out is prominently found in the longitudinal stretching immediately after extrusion. Consequently, the sheet is transported or stretched while allowing the bled-out forming solvent to be present at the interface between the sheet and the roller surface, and the sheet is put in a slippery state. When a nip roller covered with a heat-resistant rubber is arranged to parallelly come into contact with the longitudinal stretching roller and the unstretched gel-like sheet is passed therethrough, stretching can be performed while squeezing out the forming solvent from the gel-like sheet under stretching, and slip is thereby avoided, and as a result, a stabilized F25 value is obtained.

In the longitudinal stretching step, when a method of removing the forming solvent attached to the longitudinal stretching roller and the nip roller (sometimes referred to as “scraping means”) is used in combination, the effect of avoiding the slip is more efficiently obtained. The scraping means is not particularly limited, but a doctor blade, blowing with the compressed air, suction, or a combination thereof may be used. In particular, the method of scraping off the forming solvent by a doctor blade is relatively easily conducted and, therefore, the method is preferred. A method where a doctor blade is abutted on the longitudinal stretching roller to run in parallel to the width direction of the longitudinal stretching roller and the forming solvent is scraped off to the extent that the forming solvent cannot be visually recognized on the stretching roller surface in the period from immediately after passing through the doctor blade until contact by the gel-like sheet under stretching, is preferred. As to the doctor blade, one sheet may be used, or a plurality of sheets may be used. The scraping means may be disposed on either the longitudinal stretching roller or the nip roller or may be disposed on both.

The material of the doctor blade is not particularly limited as long as the material has resistance to a forming solvent, and a resin-made or rubber-made doctor blade is more preferred than a metal-made doctor blade. In a metal-made doctor blade, the stretching roller may be damaged. Examples of the resin-made doctor blade include a polyester-made doctor blade, a polyacetal-made doctor blade, a polyethylene-made doctor blade and the like.

### (d) Transverse Stretching Step

As the transverse stretching step, the longitudinally stretched gel-like sheet is stretched in the transverse direction to obtain a biaxially stretched gel-like sheet. Both ends of the longitudinally stretched gel-like sheet are fixed by using clips, and then, the clips are expanded apparat from each other in the transverse direction in a tenter. The clip-to-clip distance in a sheet advancing direction is preferably maintained at 50 mm or less from an inlet of the tenter to an outlet thereof, more preferably at 25 mm or less, and still more preferably at 10 mm or less. When the clip-to-clip distance falls within the preferred range described above, the variation range of the F25 value in the width direction can be reduced. The stretch ratio in the transverse stretching step is preferably 3 times or more, and more preferably 4 to 10 times, from the viewpoint of elasticity and strength of the polyolefin microporous membrane.

In the transverse stretching step or heat treatment step, to reduce the effect of abrupt temperature change, it is preferable to divide the inside of the tenter into 10 to 30 zones and control the temperature of each zone independently. In particular, in the zone set at a highest temperature of the heat treatment step, to not cause an abrupt temperature change between respective zones in the heat treatment step, the temperature of each zone is preferably raised with hot air in a stepwise manner in the sheet traveling direction. Furthermore, it is important to control the generation of a temperature spot in the width direction of the tenter. As the control to avoid generation of a temperature spot, the wind speed variation range in the width direction of hot air is preferably kept at 3 m/sec or less, more preferably 2 m/sec or less, still more preferably 1 m/sec or less. When the wind speed variation range of hot air is kept at 3 m/sec or less, the variation range of the F25 value in the width direction of the polyolefin microporous membrane can be reduced.

The wind speed means the wind speed on the surface of the gel-like sheet under transverse stretching, facing the outlet of the hot air blowing nozzle, and can be measured by a thermal anemometer, for example, Anemomaster Model 6161 manufactured by KANOMAX Japan Inc.

(e) Step of Removing Forming Solvent from the Biaxially Stretched Gel-Like Sheet and Drying the Sheet

The forming solvent is removed (washed) from the biaxially stretched gel-like sheet by using a washing solvent. As the washing solvent, a highly volatile solvent may be used and examples thereof include, for example, a hydrocarbon such as pentane, hexane and heptane, a chlorinated hydrocarbon such as methylene chloride and carbon tetrachloride, a fluorocarbon such as trifluoroethane, and ethers such as diethyl ether and dioxane. These washing solvents are appropriately selected depending on the forming solvent used to dissolve the polyolefin and are used individually or as a mixture. As for the washing method, examples thereof include a method of performing extraction by immersion in the washing solvent, a method of showering the washing solvent, a method of suctioning the washing solvent from the opposite side of the sheet, or a combination of these methods. The washing above is performed until the residual solvent content in the sheet becomes less than 1 wt %. The sheet is then dried, and as for the drying method, the drying may be performed by heat-drying, air-drying or the like.

### (f) Step of Heat-Treating the Dried Sheet to Obtain Polyolefin Microporous Membrane

The sheet after drying is heat-treated to obtain a polyethylene microporous membrane. The heat treatment is preferably performed at a temperature of 90 to 150° C. in view of thermal shrinkage and air permeation resistance. The residence time in the heat treatment step is not particularly limited and is usually 1 second or more and 10 minutes or less, preferably 3 seconds or more and 2 minutes or less. For the heat treatment, any of a tenter method, a roller method, a rolling method, and a free method can be employed.

In the heat treatment step, the sheet is preferably shrunk in at least one direction of the machine direction and the width direction while fixing both the machine direction and the width direction. The residual strain in the polyolefin microporous membrane can be removed by the heat treatment step. In view of thermal shrinkage rate and air permeation resistance, the shrinkage rate in the machine direction or the width direction in the heat treatment step is preferably 0.01 to 50%, more preferably 3 to 20%. Furthermore, re-heating and re-stretching may be performed to enhance the mechanical strength. The re-stretching may be either a stretching roller method or a tenter method. A functionalization step such as corona treatment step or hydrophilization step may be provided, if desired, after the steps (a) to (f).

For the tension in the course of transport from the longitudinal stretching step to the winding step in the production process of the polyolefin microporous membrane, the upper limit thereof is 60 N/m, preferably 50 N/m, and more preferably 45 N/m, and the lower limit thereof is 20 N/m, preferably 30 N/m, and more preferably 35 N/m. When the tension in the course of transport from the longitudinal stretching step to the winding step falls within the preferred range described above, an increase in the variation range of the F25 value due to flapping in the course of transport can be avoided, and the thickness variation due to deformation of the polyethylene microporous membrane can also be avoided.

In addition, in the production process of the polyolefin microporous membrane, the aerial transport distance is 2 m or less, and preferably 1.5 m or less. The aerial transport distance means the distance from a final nip roller in the longitudinal stretching step to a clip-holding start point in the transverse stretching step, or when there is a supporting roller, it means the distance from the final nip roller in the longitudinal stretching step or the clip-holding start point in the transverse stretching step to each supporting roller. By adjusting the aerial transport distance to 2 m or less, the flapping of the polyolefin microporous membrane in the course of transport can be avoided. Generally, to ensure a working area, the distance from the final nip roller in the longitudinal stretching step to the clip-holding start point in the transverse stretching step requires about 3 to 5 m. In this case, however, the supporting rollers and the like are each arranged at positions 2 m or less apart from the final nip roller in the longitudinal stretching step and the clip-holding start point in the transverse stretching step. It is necessary that the aerial transport distance is 2 m or less to produce the polyolefin microporous membrane having a thickness of less than 7 μm and a variation range of the F25 value in the lengthwise direction of 1 MPa or less.

As described above, when the longitudinal stretching and transverse stretching are highly adjusted, the variation range of the F25 value in the width direction of the polyolefin microporous membrane can be reduced. Consequently, not only the variation range of the coating thickness tends to be reduced in the later-described laminating step of a porous layer but also a battery separator roll with good winding appearance is obtained. Furthermore, the variation range of the F25 value is kept at 1 MPa or less so that even when the processing is performed at such a high speed as giving a transport rate of more than 50 m/min during winding by means of a rewinder, meandering in the course of transport in a slitting step or coating step can be avoided.

The thickness of the polyolefin microporous membrane is preferably 5 to 25 μm, from the viewpoint of an increase in battery capacity.

The air permeation resistance of the polyolefin microporous membrane is preferably 50 sec/100 ccAir to 300 sec/100 ccAir. The porosity of the polyolefin microporous membrane is preferably 30 to 70%.

The average pore size of the polyolefin microporous membrane is preferably 0.01 to 1.0 μm, from the viewpoint of pore-blocking performance.

### 3. Porous Layer

The porous layer is described below.

The porous layer is a layer that imparts or improves at least one of functions such as heat resistance, adhesion to an electrode material and electrolyte permeability. The porous layer is composed of inorganic particles and a binder. The binder plays a role in imparting or improving the functions described above and binding the inorganic particles together, and plays a role in biding the polyolefin microporous membrane and the porous layer.

Examples of the binders include at least one resin selected from the group consisting of fluororesins, acrylic resins, polyvinyl alcohol resins, cellulose resins and derivatives thereof. From the viewpoint of electrode adhesion and affinity with a nonaqueous electrolyte, the fluororesins and derivatives thereof are suitable. Examples of the fluororesins include vinylidene fluoride homopolymers, vinylidene fluoride-olefin fluoride copolymers and derivatives thereof. The vinylidene fluoride homopolymers, the vinylidene fluoride-olefin fluoride copolymers or the derivatives thereof have excellent adhesion to electrodes, high affinity with nonaqueous electrolyte and high chemical and physical stability to nonaqueous electrolyte, and therefore, they can sufficiently maintain the affinity with electrolyte even in use under a high temperature. In particular, from the viewpoint of electrode adhesion, the vinylidene fluoride-olefin fluoride copolymers are suitable. From the viewpoint of heat resistance, the polyvinyl alcohol resins, the cellulose resins or the derivatives thereof are suitable. Examples of the polyvinyl alcohol resins include polyvinyl alcohol and derivatives thereof. Examples of the cellulose resins include carboxymethylcellulose (CMC), hydroxyethylcellulose (HEC), carboxyethylcellulose, methylcellulose, ethylcellulose, cyanethylcellulose, oxyethylcellulose and derivatives thereof. The binder may be at least one kind selected from the group consisting of vinylidene fluoride homopolymers, vinylidene fluoride-olefin fluoride copolymers, cellulose resins and derivatives thereof.

When a coating solution is prepared, the binder may be used by dissolving or dispersing it in water, or may be used by dissolving it in an organic solvent which can dissolve it. When it is dissolved or dispersed in water, an alcohol or a surfactant may be added thereto. In addition, as the organic solvents for dissolving the fluororesins, examples thereof include N,N-dimethylacetamide (DMAc), N-methyl-2-pyrolidone (NMP), hexamethylphosphoric triamide (HMPA), N,N-dimethylformamide (DMF), dimethyl sulfoxide (DMSO), γ-butyrolactone, chloroform, tetrachloroethane, dichloroethane, 3-chloronaphthalene, p-chlorophenol, tetralin, acetone, acetonitrile and the like (these water and organic solvents are hereinafter sometimes described as the solvents or the dispersion media).

To reduce curl of a separator due to lamination of the porous layer, it is important that inorganic particles are contained in the porous layer. Examples of the inorganic particles include calcium carbonate, calcium phosphate, amorphous silica, crystalline glass particles, kaolin, talc, titanium dioxide, alumina, silica-alumina composite oxide particles, barium sulfate, calcium fluoride, lithium fluoride, zeolite, molybdenum sulfide, mica, boehmite and the like. In addition, crosslinked polymer particles may be added, if needed. Examples of the crosslinked polymer particles include crosslinked polystyrene particles, crosslinked acrylic resin particles, crosslinked methyl methacrylate-based particles and the like. Examples of the shape of the inorganic particle include a perfectly spherical shape, a substantially spherical shape, a plate shape, a needle shape, and a polyhedral shape but is not particularly limited.

The average particle diameter of the inorganic particles is preferably 1.5 times or more and 50 times or less, more preferably 2 times or more and 20 times or less, based on the average pore size of the polyolefin microporous membrane. When the average particle diameter falls within the preferred range described above, in the state where the binder and the particles are mixed, the pores of the polyolefin microporous membrane is prevented from blocking. As a result, the air permeation resistance can be maintained. In addition, the particle is prevented from falling off in a battery assembly step and causing a serious defect of the battery.

As for the content of the inorganic particles contained in the porous layer, the upper limit thereof is preferably 98 vol %, and more preferably 95 vol %. The lower limit thereof is preferably 50 vol %, and more preferably 60 vol %. When the amount of the particles added falls within the preferred range described above, the curl reducing effect is sufficient, and the ratio of the binder to the total volume of the porous layer is optimal.

The average thickness T(ave) of the porous layer is preferably 1 to 5 μm, more preferably 1 to 4 μm, and still more preferably 1 to 3 m. When the thickness of the porous layer falls within the preferred range described above, the thickness variation range (R) of the porous layer can be reduced. The battery separator obtained by laminating the porous layer can ensure membrane rupture strength and insulating properties when the battery separator is melted/contracted at a temperature equal to or higher than the melting point. In addition, the winding volume can be reduced, and it is suitable for an increase in battery capacity.

The porosity of the porous layer is preferably 30 to 90%, and more preferably 40 to 70%. The desired porosity is obtained by appropriately adjusting the concentration of the inorganic particles, the binder concentration or the like.

### 4. Method of Laminating Porous Layer on Polyolefin Microporous Membrane

A method of laminating the porous layer on the polyolefin microporous membrane is described below.

The battery separator can be obtained by laminating the porous layer on the polyolefin microporous membrane having a variation range of the F25 value in the width direction of 1 MPa or less. By using the polyolefin microporous membrane, the contact pressure at a contact line with a coating roller (hereinafter abbreviated as a coating contact line) easily becomes uniform in the width direction of the polyolefin microporous membrane, and the coating thickness is easily made uniform.

The method of laminating the porous layer on the polyolefin microporous membrane is not particularly limited, as long as a wet coating method is employed. However, for example, there is a method of coating the polyolefin microporous membrane with the coating solution containing a binder, an inorganic particle and a solvent or dispersing medium so as to have a predetermined thickness by the later-describe method using a known roll coating method described later, followed by drying under conditions of a drying temperature of 40 to 80° C. and a drying time of 5 to 60 sec.

Examples of the roll coating methods include, for example, a reverse roll coating method, a gravure coating method and the like. These methods may be used either alone or in combination. Among them, the gravure coating method is preferred from the viewpoint of a uniform coating thickness.

To make the thickness of the porous layer uniform, it is important that the thickness of the coating contact line between the coating roller and the polyolefin microporous membrane in the roll coating method is preferably 3 mm or more and 10 mm or less within a range of an effective coating width. When the thickness of the coating contact line falls within the range described above, the coating thickness uniform in the width direction is obtained. When the thickness of the coating contact line exceeds 10 mm, the contact pressure between the polyolefin microporous membrane and the coating roller is large, resulting in that a coating surface is easily scratched.

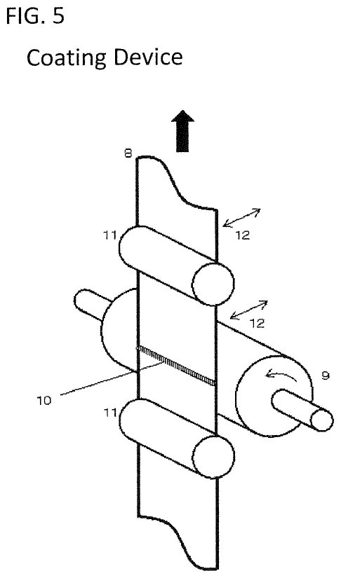

The coating contact line is a line along which the coating roller contacts with the polyolefin microporous membrane, and the thickness of the coating contact line means the width of the coating contact line in the machine direction (see FIG. 5). The thickness of the coating contact line can be measured by observing the coating contact line between the coating roller and the polyolefin microporous membrane from the back side of the polyolefin microporous membrane. The thickness of the coating contact line can be adjusted by adjusting the left/right position balance relative to the horizontal direction of the backing roller disposed at the back of the coating surface, in addition to positioning the coating roller backward/forward relative to the polyolefin microporous membrane. It is more effective to dispose the backing roller on both the upstream and downstream sides of the coating roller. In addition, the effective coating width means the width excluding 3 mm on both ends from the total coating width. This is because the coating solution locally swells or bleeds in 3 mm on both ends by the surface tension of the coating solution.

The uniform thickness of the porous layer in the width direction of the separator means that the thickness variation range (R) to the effective coating width is 1.0 μm or less. The thickness variation range (R) is preferably 0.8 μm or less, and more preferably 0.5 μm or less.

The solid concentration of the coating solution is not particularly limited as long as uniform coating of the coating solution can be performed, but is preferably 20% by weight or more and 80% by weight or less, and more preferably 50% by weight or more and 70% by weight or less. When the solid concentration of the coating solution falls within the preferred range described above, the uniform coating thickness is easily obtained, and the porous layer can be prevented from becoming brittle.

### 5. Battery Separator

The thickness of the battery separator obtained by laminating the porous layer on the polyolefin microporous membrane is preferably 4 to 12 μm, from the viewpoint of mechanical strength and battery capacity.

The length of the polyolefin microporous membrane and the battery separator is not particularly limited. However, the lower limit thereof is preferably 0.5 m, more preferably 1 m, and still more preferably 10 m. The upper limit thereof is preferably 10000 m, more preferably 8000 m, and still more preferably 7000 m. When the length is less than 0.5 m, not only it is difficult to produce a high-capacity battery, but also productivity is reduced. When the length exceeds 10000 m, the weight is too large, resulting in easy occurrence of deflection due to its own weight when formed into a roll.

As for the width of the polyolefin microporous membrane and the battery separator, the lower limit thereof is preferably 100 mm, more preferably 500 mm, and still more preferably 800 mm. The upper limit thereof is not particularly limited. However, the upper limit thereof is preferably 3000 mm, more preferably 2000 mm, and still more preferably 1500 mm. When the width is less than 100 mm, it is not adoptable to an increase in size of a battery in future. When the width exceeds 3000 mm, uniform coating is difficult, and deflection due to its own weight sometimes occurs.

It is desirable to store the battery separator in a dry state. However, when storage thereof in an absolute dry state is difficult, it is preferred to perform a reduced-pressure drying treatment at 100° C. or lower just before use.

The air permeation resistance of the battery separator is preferably 50 to 600 sec/100 ccAir.

The battery separator can be used as a separator for a secondary battery such as a nickel-hydrogen battery, a nickel-cadmium battery, a nickel-zinc battery, a silver-zinc battery, a lithium secondary battery or a lithium polymer secondary battery, a plastic film capacitor, a ceramic capacitor, an electric double layer capacitor or the like, but is preferably used as a separator for a lithium ion secondary battery. Description is made below taking as an example the lithium ion secondary battery. The lithium ion secondary battery contains an electrode body in which a cathode and an anode are laminated with the interposition of a separator, and an electrolytic solution (electrolyte). The structure of the electrode body is not particularly limited, and may be a known structure. For example, an electrode structure in which disc-shaped cathode and anode are arranged to face each other (a coin type), an electrode structure in which planar cathodes and anodes are alternately laminated (a lamination type), an electrode structure in which band-shaped cathode and anode are overlapped and wound (a winding type) and the like can be employed.

### EXAMPLES

Our membranes, separators and methods are specifically described below by referring to Examples, but this disclosure is not limited by these Examples in any way. The measured values in Examples are a value measured by the following methods.

### 1. Measurement of Variation Range of F25 Value

A specimen of TD 10 mm×MD 50 mm was cut out at 4 positions equally spaced relative to the width direction of the polyolefin microporous membrane obtained in Examples and Comparative Examples. The specimen in both edge parts was cut out at a position of 30 mm to 40 mm from the edge part in the width direction of the microporous membrane. In conformity with JIS K7113, an SS curve (the relationship between normal stress (stress) and normal strain (strain)) in the machine direction of the specimen was determined using a tabletop precision universal tester (Autograph AGS-J, manufactured by Shimadzu Corporation). The normal stress value at 25% elongation of normal strain was read, and the value was divided by the cross-sectional area of each specimen. Three sheets of each specimen were measured for each measurement position, and the average thereof was defined as the F25 value at each measurement position. The variation range of the F25 value was determined from the difference between maximum value and minimum of the F25 value at each measurement position. A polyolefin microporous membrane obtained by peeling and removing the porous layer from the battery separator may be used for the specimen as well.

Measurement Conditions:
Load cell capacity: 1 kN
Clip-to-clip distance: 20 mm
Test speed: 20 mm/min
Measurement environment: temperature 20° C. and relative humidity 60%

### 2. Thickness Variation Range (R) in Width Direction of Porous Layer

A specimen of TD 10 mm×MD 50 mm was cut out at 4 positions equally spaced relative to the width direction of the battery separator obtained in Examples and Comparative Examples. The specimen in both edge parts was cut out at a position of 30 mm to 40 mm from the edge part in the width direction of the separator. The thickness of the porous layer was determined by observing SEM images (magnification: 10,000 time) of the cross-section of each specimen. The cross-sectional specimen was prepared using cryo CP method and after depositing a minute amount of fine metal particles so as to prevent charge-up of the electron beam, an SEM image was observed. The boundary line between the polyolefin microporous membrane and the porous layer was confirmed from the existence region of inorganic particles. Three sheets of each specimen were measured for each measurement position and taking an average value of thicknesses at a total of 12 points as the average thickness T(ave) of the porous layer, the difference between maximum value and minimum value thereof was determined from the average thickness of the porous layer at each measurement position and defined as the thickness variation range (R) of the porous layer relative to the width direction.

Measurement Instrument:

Field emission scanning electron microscope (FE-SEM) S-4800, manufactured by Hitachi High-Technologies Corporation

Cross-section polisher (CP) SM-9010 (manufactured by JEOL Ltd.)

Measurement Conditions:

Acceleration voltage: 1.0 kV

### 3. Measurement of Thickness of Coating Contact Line

A coating contact line is a line in a width direction, along which a coating roller contacts with the polyolefin microporous membrane during coating. The thickness of the coating contact line is the width of the coating contact line in a machine direction, and means a value which is read using a scale through a rear surface of the polyolefin microporous membrane.

### 4. Winding Appearance

Rolls of the battery separators obtained in Examples and Comparative Examples were visually observed, and the number of defects of gauge bands, bulges of roll ends and waviness was counted.

Evaluation Criteria
A (good): none
B (acceptable): 1 to 3 defects
C (poor): 4 or more defects

### 5. Transportability

The left and right deflection range of the polyolefin microporous membrane was read during coating the polyolefin microporous membrane at a transport rate of 50 m/min for a length of 1000 m.

Evaluation Criteria
A (good): less than 5 mm
B (acceptable): 5 to 10 mm
C (poor): exceeding 10 mm

### 6. Evaluation of Scratch

From each of rolls of the battery separators obtained in Examples and Comparative Examples, an outermost portion was removed and, thereafter, 1 m² of an inner peripheral portion was pulled out to prepare a sample for evaluation. For scratch detection, Brome Light (lighting equipment used for photographic shooting or video recording) was used to light on a coating surface, and scratches were visually detected. Then, the number of the scratches was counted.

Evaluation Criteria
A (good): 1 or less
B (acceptable): from 2 to 5
C (poor): 6 or more

### Example 1

### Production of Polyolefin Microporous Membrane

With 100 parts by mass of a composition composed of 40% by mass of an ultra-high molecular weight polyethylene having a mass average molecular weight of 2.5×10⁶ and 60% by mass of a high-density polyethylene having a mass average molecular weight of 2.8×10⁵, 0.375 parts by mass of tetrakis [methylene-3-(3,5-ditertiary-butyl-4-hydroxyphenyl)propionate]methane was dry-blended to prepare a polyethylene composition. 30 parts by weight of the polyethylene composition obtained was introduced into a biaxial extruder, and 70 parts by weight of liquid paraffin was supplied through a side-feeder of the biaxial extruder, followed by melt-kneading to prepare a polyethylene resin solution in the extruder. Subsequently, the polyethylene resin solution was extruded through a die disposed at an end of the extruder at 190° C., and an unstretched gel-like sheet was formed while taking it up around a cooling roller in which the temperature of internal cooling water was kept at 25° C. The sheet was allowed to pass through 4 pre-heat roller groups to adjust the temperature of a sheet surface to 110° C.

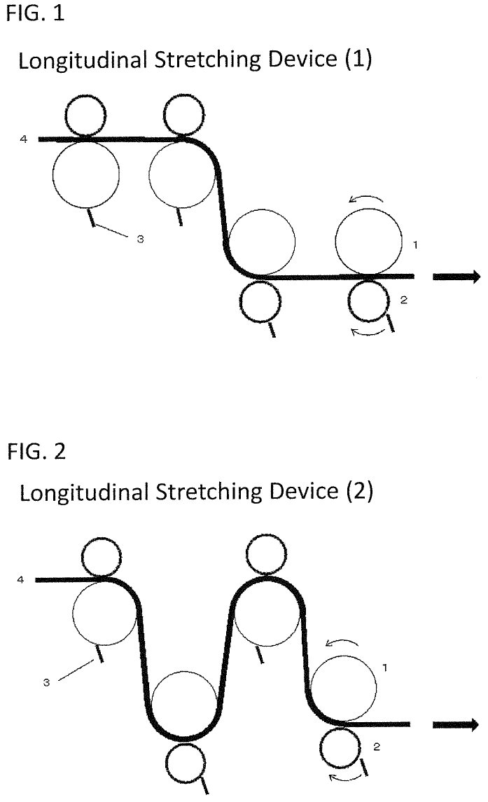

Thereafter, the sheet was stretched at a stretch ratio of 7 times in a longitudinal direction with a longitudinal stretching device (1) shown in FIG. 1, and allowed to pass through 4 cooling rollers to cool the sheet to a temperature of 50° C. Thus, a longitudinally stretched gel-like sheet was formed. A metal roller (surface roughness: 0.5 S) plated with hard chromium, which had a width of 1000 mm and a diameter of 300 mm, was used as the longitudinal stretching roller. The surface temperature of each longitudinal stretching roller was 110° C., and the temperature variation range of each roller was within ±2° C. A polyester-made doctor blade was used as a doctor blade. A nitrile rubber-coated roller (manufacture by Katsura Roller Mfg. Co., Ltd.) was used as a nip roller. The pressure of each nip roller at this time was 0.3 MPa. The peripheral speed ratio of the respective stretching rollers was set so that the rotational speed of the respective stretching rollers in the longitudinal stretching device (1) became faster towards the downstream side.

Both ends of the longitudinally stretched gel-like sheet obtained were held by clips, and the sheet was stretched at a stretch ratio of 6 times in a transverse direction at a temperature of 115° C. in a tenter divided into 20 zones to form a biaxially stretched gel-like sheet. At this time, the clip-to-clip distance in a sheet advancing direction was 5 mm from an inlet of the tenter to an outlet thereof. The variation range of the wind speed of hot air in a width direction in the tenter was adjusted to 3 m/sec or less. A supporting roller was arranged so that the aerial transport distance became 1.5 m.

The biaxially stretched gel-like sheet obtained was cooled to 30° C., and liquid paraffin was removed in a washing tank of methylene chloride which had a temperature controlled to 25° C., followed by drying in a drying furnace adjusted to 60° C. The resulting dried sheet was re-stretched at a longitudinal stretch ratio of 1.2 times by a re-stretching device shown in FIG. 4, and heat-treated at 125° C. for 20 seconds to obtain a polyolefin microporous membrane having a thickness of 5 μm. A polyolefin microporous membrane roll having a width of 2000 mm and a length of 5050 m was obtained at a tension of 45 N/m in the course of transport from the longitudinal stretching step to the winding step and a transport rate during winding of 50 m/min. Further, the polyolefin microporous membrane was slit to have a width of 950 mm to obtain a polyolefin microporous membrane (A) as a coating substrate.

### Example 2

A polyolefin microporous membrane (B) as a coating substrate was obtained in the same manner as in Example 1, except that the width was changed to 150 mm.

### Example 3

A polyolefin microporous membrane (C) as a coating substrate was obtained in the same manner as in Example 1, except that the width was changed to 1950 mm.

### Example 4

A polyolefin microporous membrane (D) as a coating substrate was obtained in the same manner as in Example 1, except that the thickness was changed to 6 μm by adjusting the extrusion amount of the polyethylene resin solution.

### Example 5

A polyolefin microporous membrane (E) as a coating substrate was obtained in the same manner as in Example 1, except that the pressure of each nip roller was changed to 0.1 MPa.

### Example 6

A polyolefin microporous membrane (F) as a coating substrate was obtained in the same manner as in Example 1, except that the pressure of each nip roller was changed to 0.5 MPa.

### Example 7

A polyolefin microporous membrane (G) as a coating substrate was obtained in the same manner as in Example 1, except that ceramic-coated metal rollers having a surface roughness of 5.0 S were used for all the four longitudinal stretching rollers.

### Example 8

A polyolefin microporous membrane (H) was obtained in the same manner as in Example 1, except that a longitudinal stretching device (2) shown in FIG. 2 was used as a stretching device in place of the longitudinal stretching device (1).

### Example 9

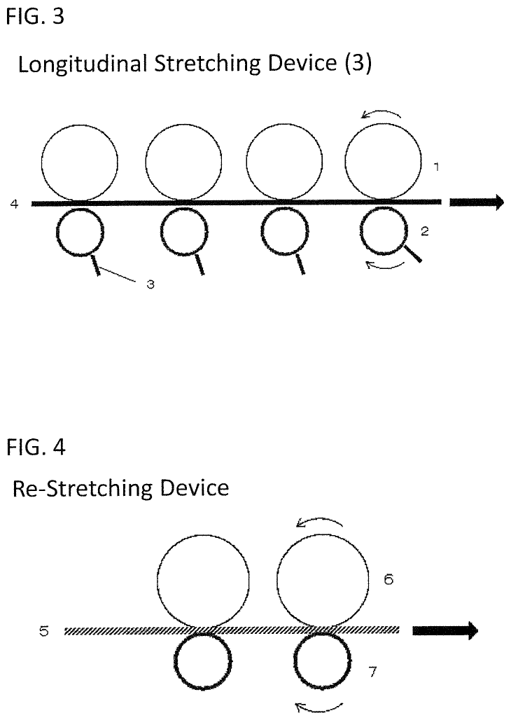

A polyolefin microporous membrane (I) was obtained in the same manner as in Example 1, except that a longitudinal stretching device (3) shown in FIG. 3 was used as a stretching device in place of the longitudinal stretching device (1).

### Example 10

A polyolefin microporous membrane (J) having a thickness of 3 μm was obtained in the same manner as in Example 1 by adjusting the extrusion amount of the polyethylene resin solution.

### Comparative Example 1

polyolefin microporous membrane (K) was obtained in the same manner as in Example 1, except that no nip roller was used for each of the four stretching rollers.

### Comparative Example 2

A polyolefin microporous membrane (L) was obtained in the same manner as in Example 1, except that the pressure of each nip roller was changed to 0.04 MPa.

### Comparative Example 3

A polyolefin microporous membrane (M) was obtained in the same manner as in Example 1, except that hard chromium plated metal rollers having a surface roughness of 0.1 S were used as the longitudinal stretching rollers.

### Comparative Example 4

A polyolefin microporous membrane (N) was obtained in the same manner as in Example 1, except that the temperature variation range of each longitudinal stretching roller was within ±3° C.

### Comparative Example 5

A polyolefin microporous membrane (O) was obtained in the same manner as in Example 1, except that a longitudinal stretching device B was used as a stretching device in place of the longitudinal stretching device A and that no nip roller was used for each of the four longitudinal stretching rollers.

### Comparative Example 6

A polyolefin microporous membrane (P) was obtained in the same manner as in Example 1, except that the tension in the course of transport from the longitudinal stretching step to the winding step was adjusted to 50 N/m and that aerial transport distance from the final nip roller in the longitudinal stretching step to the clip-holding start point in the transverse stretching step was 5 m.

### Preparation of Coating Solution

### Reference Example 1

Polyvinyl alcohol (average polymerization degree: 1700, saponification degree: 99% or more), alumina particles (average particle diameter: 0.5 m) and ion exchange water were blended in a weight ratio of 6:54:40, followed by sufficiently stirring and uniformly dispersing. Then, filtration was performed through a filter having a filtration limit of 5 μm to obtain a coating solution (a).

### Reference Example 2

A copolymer of polyvinyl alcohol, acrylic acid and methyl methacrylate (“POVACOATR” (registered trade mark) manufactured by Nissin Kasei Co, Ltd.), alumina particles (average particle diameter: 0.5 μm) and a solvent (ion exchange water:ethanol=70:30) were blended in a weight ratio of 5:45:50, followed by sufficiently stirring and uniformly dispersing. Then, filtration was performed through a filter having a filtration limit of 5 μm to obtain a coating solution (b).

### Reference Example 3

As fluororesins, a vinylidene fluoride-hexafluoropropylene copolymer (weight average molecular weight: 1,000,000, VdF/HFP=92/8 (weight ratio)) and a vinylidene fluoride-hexafluoropropylene copolymer (weight average molecular weight: 600,000, VdF/HFP=88/12 (weight ratio)) were mixed in such a blending ratio that the solution viscosity of a coating solution was 100 mPa·s. The fluororesin components were dissolved in N-methyl-2-pyrrolidone, and alumina particles (average particle diameter: 0.5 μm) were added thereto and uniformly dispersed. Thereafter, filtration was performed through a filter having a filtration limit of 5 m to prepare a coating solution (c). The coating solution (c) contained 50% by volume of alumina particles based on the total volume of the fluororesins and the alumina particles, and the solid concentration thereof was 10% by weight.

### Preparation of Battery Separator

### Example 11

Using a coating device (a gravure coat method) shown in FIG. 5, the polyolefin microporous membrane (A) obtained in Example 1 was coated with the coating solution (a) at a transport ratio of 50 m/min, allowed to pass through a hot-air drying furnace at 50° C. for 10 seconds to dry the coating solution, and slit to obtain a battery separator having a porous layer thickness of 2 μm, a length of 5000 m and a width of 900 mm and a roll thereof. At this time, the thickness of a coating contact line was set to the range of 3 to 5 mm by adjusting the positions of a coating roller (gravure roller) and back roller in the coating device.

### Example 12

A battery separator and a roll thereof were obtained in the same manner as in Example 11, except that the battery separator was slit to have a width of 130 mm using the polyolefin microporous membrane (B) obtained in Example 2.

### Example 13

A battery separator and a roll thereof were obtained in the same manner as in Example 11, except that the thickness of a coating contact line was set to the range of 4 to 9 mm by adjusting the positions of the gravure roller and back roller in the coating device, and that the battery separator was slit to have a width of 1900 mm, using the polyolefin microporous membrane (C) obtained in Example 3.

### Examples 14 to 20

Battery separators and rolls thereof were obtained in the same manner as in Example 11, except that the polyolefin microporous membranes (D) to (J) obtained in Examples 4 to 9 were used, respectively.

### Example 21

A battery separator and a roll thereof were obtained in the same manner as in Example 11, except that the coating solution (a) was replaced by the coating solution (b).

### Example 22

A battery separator and a roll thereof were obtained in the same manner as in Example 11, except that the coating solution (a) was replaced by the coating solution (c).

### Example 23

A battery separator and a roll thereof were obtained in the same manner as in Example 11, except that the thickness of a coating contact line was set to the range of 5 to 7 mm by adjusting the positions of the gravure roller and back roller in the coating device.

### Example 24

A battery separator and a roll thereof were obtained in the same manner as in Example 11, except that the thickness of a coating contact line was set to the range of 8 to 10 mm by adjusting the positions of the gravure roller and back roller in the coating device.

### Example 25

A battery separator and a roll thereof were obtained in the same manner as in Example 11, except that the porous layer thickness was adjusted to 5 μm by changing the cell capacity of the gravure roller in the coating device.

### Example 26

A battery separator was obtained in the same manner as in Example 11, except that the coating solution (c) was used in replace of the coating solution (a), and that the porous layer was placed on both surfaces of the polyolefin microporous membrane (A).

### Comparative Examples 7 to 12

Battery separators and rolls thereof were obtained in the same manner as in Example 11, except that polyolefin microporous membranes (K) to (P) obtained in Comparative Examples 1 to 6 were used, respectively.

### Comparative Example 13

A battery separator and a roll thereof were obtained in the same manner as in Example 11, except that the cell capacity of the gravure roller in the coating device was changed so that the porous layer thickness was 8 μm.

### Comparative Example 14

A battery separator and a roll thereof were obtained in the same manner as in Example 11, except that the thickness of a coating contact line was set to the range of 11 to 15 mm by adjusting the positions of the gravure roller and back roller in the coating device.

### Comparative Example 15

A battery separator and a roll thereof were obtained in the same manner as in Example 11, except that the thickness of a coating contact line was set to the range of 20 to 25 mm by adjusting the positions of the gravure roller and back roller in the coating device.

The production conditions of the polyolefin microporous membranes obtained in Examples 1 to 10 and Comparative Examples 1 to 6 and the properties thereof are shown in Table 1. The production conditions of the battery separators obtained in Example 11 to 26 and Comparative Examples 7 to 15 and the properties of the battery separators and the rolls thereof are shown in Table 2.

TABLE 1

| | | Surface | | | | | | | |
|---|---|---|---|---|---|---|---|---|---|
| | | Roughness of | | Surface | | | | | |
| | | Longitudinal | | Temperature of | Aerial | | Variation | Width of | Thickness |
| | Longitudinal | Stretching | Nip | Longitudinal | Transport | Wind Speed | Range of | PE | of PE |
| | Stretching | Roller | Pressure | Stretching Roller | Distance | Variation Range in | F25 Value | Membrane | Membrane |
| | Device | (S) | (MPa) | (° C.) | (m) | Width Direction | (MPa) | (mm) | (μm) |
| Example 1 | (1) | 0.5 | 0.3 | 110 ± 2 | 1.5 | 3 m/s or less | 0.7 | 950 | 5 |
| Example 2 | (1) | 0.5 | 0.3 | 110 ± 2 | 1.5 | 3 m/s or less | 0.1 | 150 | 5 |
| Example 3 | (1) | 0.5 | 0.3 | 110 ± 2 | 1.5 | 3 m/s or less | 1 | 1950 | 5 |
| Example 4 | (1) | 0.5 | 0.3 | 110 ± 2 | 1.5 | 3 m/s or less | 0.7 | 950 | 6 |
| Example 5 | (1) | 0.5 | 0.1 | 110 ± 2 | 1.5 | 3 m/s or less | 0.9 | 950 | 5 |
| Example 6 | (1) | 0.5 | 0.5 | 110 ± 2 | 1.5 | 3 m/s or less | 0.5 | 950 | 5 |
| Example 7 | (1) | 5.0 | 0.3 | 110 ± 2 | 1.5 | 3 m/s or less | 0.5 | 950 | 5 |
| Example 8 | (2) | 0.5 | 0.3 | 110 ± 2 | 1.5 | 3 m/s or less | 0.6 | 950 | 5 |
| Example 9 | (3) | 0.5 | 0.3 | 110 ± 2 | 1.5 | 3 m/s or less | 0.7 | 950 | 5 |
| Example 10 | (1) | 0.5 | 0.3 | 110 ± 2 | 1.5 | 3 m/s or less | 0.8 | 950 | 3 |
| Comparative | (1) | 0.5 | — | 110 ± 2 | 1.5 | 3 m/s or less | 2.1 | 950 | 5 |
| Example 1 | | | | | | | | | |
| Comparative | (1) | 0.5 | 0.04 | 110 ± 2 | 1.5 | 3 m/s or less | 2.0 | 950 | 5 |
| Example 2 | | | | | | | | | |
| Comparative | (1) | 0.1 | 0.3 | 110 ± 2 | 1.5 | 3 m/s or less | 1.3 | 950 | 5 |
| Example 3 | | | | | | | | | |
| Comparative | (1) | 0.5 | 0.3 | 110 ± 3 | 1.5 | 3 m/s or less | 1.4 | 950 | 5 |
| Example 4 | | | | | | | | | |
| Comparative | (2) | 0.5 | — | 110 ± 2 | 1.5 | 3 m/s or less | 2.0 | 950 | 5 |
| Example 5 | | | | | | | | | |
| Comparative | (1) | 0.5 | 0.3 | 110 ± 2 | 5 | 3 m/s or less | 1.2 | 950 | 5 |
| Example 6 | | | | | | | | | |

TABLE 2

| | | | Thickness of | | Porous Layer Thickness | | | |
|---|---|---|---|---|---|---|---|---|
| | | | Coating Contact | Thickness of | Variation Range in Width | | | |
| | PE | Coating | Line | Porous Layer | Direction | Winding | | |
| | Membrane | Solution | (mm) | (μm) | (μm) | Appearance | Transportability | Scratch |
| Example 11 | A | a | 3 to 5 | 2 | 0.6 | A | A | A |
| Example 12 | B | a | 3 to 5 | 2 | 0.1 | A | A | A |
| Example 13 | C | a | 4 to 9 | 2 | 0.9 | A | A | A |
| Example 14 | D | a | 3 to 5 | 2 | 0.6 | A | A | A |
| Example 15 | E | a | 3 to 5 | 2 | 0.8 | A | A | A |
| Example 16 | F | a | 3 to 5 | 2 | 0.4 | A | A | A |
| Example 17 | G | a | 3 to 5 | 2 | 0.5 | A | A | A |
| Example 18 | H | a | 3 to 5 | 2 | 0.5 | A | A | A |
| Example 19 | I | a | 3 to 5 | 2 | 0.7 | A | A | A |
| Example 20 | J | a | 3 to 5 | 2 | 0.7 | A | A | A |
| Example 21 | A | b | 3 to 5 | 2 | 0.6 | A | A | A |
| Example 22 | A | c | 3 to 5 | 2 | 0.6 | A | A | A |
| Example 23 | A | a | 5 to 7 | 2 | 0.6 | A | A | A |
| Example 24 | A | a | 8 to 10 | 2 | 0.6 | A | A | A |
| Example 25 | A | a | 3 to 5 | 5 | 0.8 | A | A | A |
| Example 26 | A | c | 3 to 5 | 2 | 0.6 | A | A | A |
| Comparative | K | a | 3 to 5 | 2 | 2.3 | C | C | A |
| Example 7 | | | | | | | | |
| Comparative | L | a | 3 to 5 | 2 | 2.1 | B | B | A |
| Example 8 | | | | | | | | |
| Comparative | M | a | 3 to 5 | 2 | 1.6 | B | B | A |
| Example 9 | | | | | | | | |
| Comparative | N | a | 3 to 5 | 2 | 1.7 | B | B | A |
| Example 10 | | | | | | | | |
| Comparative | O | a | 3 to 5 | 2 | 2.1 | B | B | A |
| Example 11 | | | | | | | | |
| Comparative | P | a | 3 to 5 | 2 | 1.4 | B | B | A |
| Example 12 | | | | | | | | |
| Comparative | A | a | 3 to 5 | 8 | 1.1 | A | A | A |
| Example 13 | | | | | | | | |
| Comparative | A | a | 11 to 15 | 2 | 0.6 | A | A | B |
| Example 14 | | | | | | | | |
| Comparative | A | a | 20 to 25 | 2 | 0.6 | A | A | C |
| Example 15 | | | | | | | | |

1.-9. (canceled)

10. A polyolefin microporous membrane having a variation range of an F25 value in a width direction of 1 MPa or less, a thickness of 3 μm or more and less than 7 μm and a width of 100 mm or more, wherein the F25 value indicates a value obtained by dividing a load value measured at 25% elongation of a specimen with use of a tensile tester by a cross-sectional area of the specimen.

11. A battery separator, comprising the polyolefin microporous membrane according to claim 10 and a porous layer placed on at least one surface of the polyolefin microporous membrane, wherein the porous layer contains a particle and at least one binder selected from the group consisting of a fluororesin, an acrylic resin, a polyvinyl alcohol resin, a cellulose resin and a derivative thereof and has an average thickness T(ave) of 1 to 5 μm.

12. The battery separator according to claim 11, wherein the porous layer has a thickness variation range (R) in a width direction of 1.0 μm or less.

13. The battery separator according claim 11, wherein the polyolefin microporous membrane has a width of 150 mm or more.

14. The battery separator according claim 11, wherein the polyolefin microporous membrane has a width of 200 mm or more.

15. A method of producing the polyolefin microporous membrane according to claim 1, the method comprising:
(a) a step of melt-kneading a polyolefin resin and a forming solvent, thereby preparing a polyolefin resin solution;
(b) a step of extruding the polyolefin resin solution into a sheet shape via an extruder and cooling an extrudate thereof, thereby forming an unstretched gel-like sheet;
(c) a step of passing the unstretched gel-like sheet between at least two pairs of longitudinal stretching roller groups and stretching it in a longitudinal direction by the two pairs of roller groups different in a peripheral speed ratio, thereby forming a longitudinally stretched gel-like sheet, wherein a longitudinal stretching roller and a nip roller parallelly contacting therewith are designated as a pair of longitudinal stretching roller group, and a contact pressure of the nip roller to the longitudinal stretching roller is 0.05 MPa or more and 0.5 MPa or less;
(d) a step of stretching the longitudinally stretched gel-like sheet in a transverse direction while holding it to allow a clip-to-clip distance to be 50 mm or less at a tenter outlet, thereby obtaining a biaxially stretched gel-like sheet;
(e) a step of extracting the forming solvent from the biaxially stretched gel-like sheet and drying it; and
(f) a step of heat-treating the dried sheet, thereby obtaining a polyolefin microporous membrane.

16. A method of producing a polyolefin microporous membrane roll, the method comprising a step of winding a polyolefin microporous membrane obtained by the method of producing the polyolefin microporous membrane according to claim 15 on a winding core at a transport rate of 50 m/min or more.

17. A method of producing a battery separator, the method comprising a step of coating at least one surface of a polyolefin microporous membrane obtained by the method of producing the polyolefin microporous membrane according to claim 15 with a coating solution containing a particle and at least one binder selected from the group consisting of a fluororesin, an acrylic resin, a polyvinyl alcohol resin, a cellulose resin and a derivative thereof by a roll coating method so that a thickness of a coating contact line between a coating roller and the polyolefin microporous membrane is 3 mm or more and 10 mm or less, followed by drying.

18. The method according to claim 17, wherein the coating roller is a gravure roller.
